(19) United States
(12) Patent Application Publication
(10) Pub. No.: US 2018/0261947 A1
(43) Pub. Date: Sep. 13, 2018

(54) LEVERED ELECTRICAL OUTLET PLUG PROTECTOR

(71) Applicant: Lora Foster, Alliance, OH (US)

(72) Inventor: Lora Foster, Alliance, OH (US)

(21) Appl. No.: 15/919,718

(22) Filed: Mar. 13, 2018

Related U.S. Application Data
(60) Provisional application No. 62/470,606, filed on Mar. 13, 2017.

(51) Int. Cl. H01R 13/443

(52) U.S. Cl. CPC H01R 13/443

(57) ABSTRACT

An electrical outlet plug protector has a body with a centerline, an outward surface, an inserting surface, and one or more arms connected to and extending laterally away from the body. The inserting surface has one or more projections disposable within an electrical outlet plug receptacle. One or more arms include a lever means for removing the electrical outlet plug protector from an electrical outlet plug receptacle.

### CROSS-REFERENCE TO RELATED APPLICATION

This application claims the benefit of U.S. Provisional Patent Application Ser. No. 62/470,606, filed Mar. 13, 2017.

### BACKGROUND OF THE INVENTION

### Field of the Invention

The invention relates to electrical outlets, and particularly to plug protectors for those outlets of the type that receive the pins of a plug of an electrical cord. More particularly, the invention relates to a levered electrical outlet plug protector which is designed to protect children from electrical shock, provides for easy removal of the protector, and includes a fanciful face and design that is aesthetically pleasing.

### Background Art

Electricity generally is provided through an electrical outlet to residential and/or other structures. The electrical outlet includes a socket with socket female openings for receiving a plug which is connected to an electrical cord of an electrical device. Since these electrical outlets are placed close to the floor for convenience, a child has easy access to them. As a result, child electrical accidents have been repeatedly reported which were caused by inserting foreign objects into the plug.

Electrical outlet plug protectors or electrical outlet covers have been known for preventing electrical accidents and alleviating the danger of electrical shock. Various safety devices are known that prevent children from inserting foreign objects into the plug and thereby preventing injury. One known electrical outlet plug protector is made from non-conducting material, such as plastic, and has a plug-like shape with pins and a cover component. By inserting the pins of the plug-shaped electrical outlet plug protector into the socket female openings, the cover component covers the socket female openings and/or the entire socket so that children are prevented from putting foreign objects into the socket female openings. One of the limitations of such a device is that it is plugged into the socket in such a tight-fit manner that adults can break their finger nails in their attempts to unplug the device from the socket, thereby at least partially negating its utility.

Another known electrical outlet plug protector includes a structure which enables relatively easy unplugging of the electrical outlet plug protector. The structure has a pair of finger pads and a retainer. The retainer engages a flange associated with a ground prong receiver opening in a socket thereby locking the electrical outlet plug protector into the socket. The locking engagement between the retainer and the flange minimizes the relative movement between the plug and the socket and therefore allows the plug protector to have relatively loose plugging of pins of the plug protector into the female openings of the socket. This relatively loose plugging provides relatively easy unplugging of the protector which requires a small force. One of the limitations of such a device is that it has a complicated structure which increases the required time and cost for manufacturing the device. Another limitation is that the use of the device is complex.

As a result, there is a need for an electrical outlet plug protector that protects children from electrical shock, provides easy removal of the plug protector while preventing breaking of finger nails, and that is fanciful and/or aesthetically pleasing. In addition, there is a need for an electrical plug protector that is inexpensive, easy to manufacture and use, yet effective for protecting children. The levered electrical outlet plug protector satisfies these needs.

### SUMMARY OF THE INVENTION

The disclosed subject matter provides a levered electrical outlet plug protector that protects children from electrical shock and provides easy insertion and removal of the plug protector while preventing an individual from breaking finger nails during its insertion, use, and removal.

The disclosed subject matter also provides a levered electrical outlet plug protector that is inexpensive and easy to manufacture.

The disclosed subject matter also provides a levered electrical outlet plug protector that is fanciful and/or aesthetically pleasing.

The levered electrical outlet plug protector of the disclosed subject matter has at least a body with an outward surface and an inserting surface having a pair of projections or dummy plug pins with or without a ground pin, and a pair of arms. The arms generally include a lever component attached to or integrally formed on the back surface and are connected to and extend laterally away from the body of the levered electrical outlet plug protector.

### BRIEF DESCRIPTION OF THE SEVERAL VIEWS OF THE DRAWINGS

The preferred embodiment of the present invention, illustrative of the best mode in which applicant has contemplated applying the principles, is set forth in the following description and is shown in the drawings, and is particularly and distinctly pointed out and set forth in the appended claims.

FIG. 1 is an elevational view of a prior art electrical outlet plug protector inserted into a socket;

FIG. 1A is an elevational view of an inserting surface of the prior art electrical outlet plug protector shown in FIG. 1;

FIG. 2 is an elevational view of an exemplary embodiment levered electrical outlet plug protector inserted into a socket;

FIG. 3 is an elevational view of an inserting surface of the exemplary embodiment levered electrical outlet plug protector shown in FIG. 2;

FIG. 3A is a top plan view of the exemplary embodiment levered electrical outlet plug protector shown in FIG. 2 inserted into a socket;

FIG. 3B is a top plan view of the exemplary embodiment levered electrical outlet plug protector shown in FIG. 2 partially unplugged from a socket;

FIG. 3C is a top plan view of an alternative exemplary embodiment levered electrical outlet plug protector shown inserted into a socket; and

FIG. 4 is a perspective view of the exemplary embodiment levered electrical outlet plug protector shown in FIG. 2 partially unplugged from a socket.

Similar numerals refer to similar parts throughout the drawings.

### DESCRIPTION OF THE PREFERRED EMBODIMENT

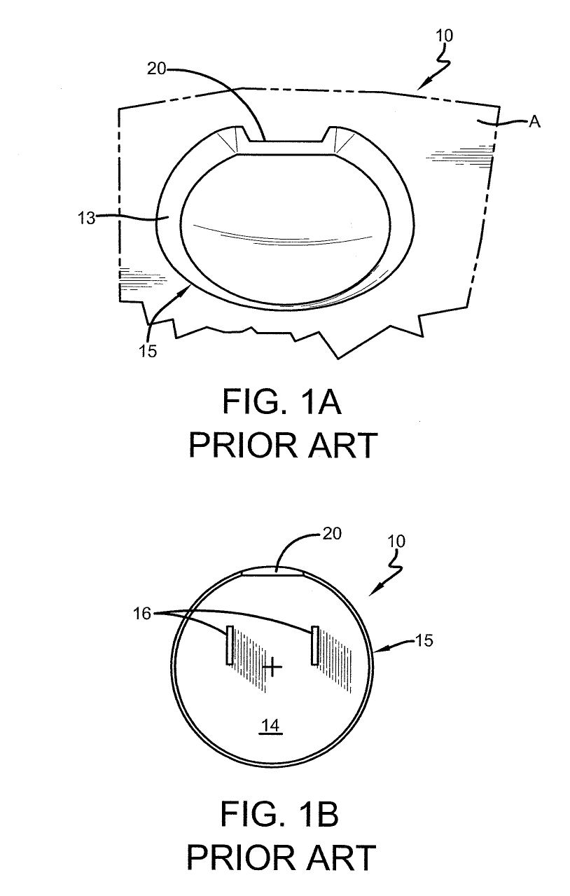

In order to better understand the structure and operation of the levered electrical outlet plug protector of the present invention and the environment in which it operates, components of a prior art electrical outlet plug protector and structures upon which they are mounted are shown in FIGS. 1 and 1A. A prior art electrical outlet plug protector 10 is made from non-conducting material, such as plastic. Electrical outlet plug protector 10 includes a generally cylindrical body 15. Cylindrical body 15 has an outward surface 12, inserting surface 14, and a curved sidewall 13 raised along a circumference of the cylindrical body. Inserting surface 14 includes a pair of dummy plug pins 16. Curved sidewall 13 includes a partially disconnected portion 20 which provides a space between inserting surface 14 and a socket front surface A when electrical outlet plug protector 10 is installed to the socket.

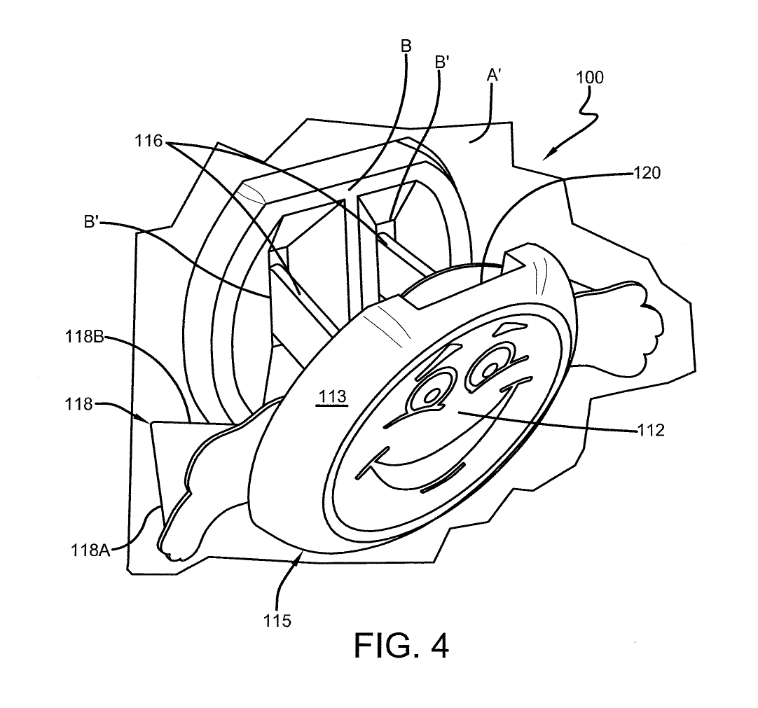

Electrical outlet plug protector 10 is installed to the socket by inserting pair of dummy plug pins 16 into a pair of socket female openings B, shown in FIG. 4. Once electrical outlet plug protector 10 is installed, it is relatively secured to the socket by a friction fit between dummy plug pins 16 and socket female openings B. Other than the space between inserting surface 14 and socket front surface A provided by partially disconnected portion 20 of curved sidewall 13 of electrical plug protector cylindrical body 15, there is nearly no space formed between the socket front surface A and the inserting surface of the electrical protector cylindrical body. This makes it difficult to unplug electrical outlet plug protector 10 when required, such as during use of the socket. Generally finger nails are used to remove electrical outlet plug protector 10 from the socket. By inserting the finger nails into the space between inserting surface 14 and socket front surface A, or into the space between disconnected portion 20 and socket front surface A, or by forcibly grabbing or pinching curved sidewall 13 of electrical plug protector cylindrical body 15, electrical plug protector 10 is removed from the socket. It has been known that finger nails can be broken and/or finger tips can be injured during these attempts to unplug using force.

Another prior art electrical outlet plug protector (not shown) includes a structure which enables relatively easy unplugging of the electrical outlet plug protector. The structure has a pair of finger pads and a retainer. The retainer engages a flange associated with a ground prong receiver opening in a socket thereby locking the electrical outlet plug protector to the socket. The locking engagement between the retainer and the flange minimizes the relative movement between the plug and the socket and therefore allows the plug protector to have relatively loose plugging of the pins of the plug protector into the female openings of the socket. This loose plugging allows for easy unplugging which requires a small force. One of the limitations of such a device is that it has a complicated structure, which increases the require time and cost for manufacturing the device. Another limitation is that the use of the device is complex.

The above-described disadvantages of prior art electrical outlet plug protectors have created a need in the art for an improved electrical outlet plug protector that is satisfied by the present invention. The levered electrical outlet plug protector of the present invention includes a body and at least a pair of arms connected to the body. Each arm includes a lever component which operates as a lever for the body to be lifted from a socket front surface when it is installed into the socket, thereby facilitating relatively easy unplugging of the levered electrical outlet plug protector.

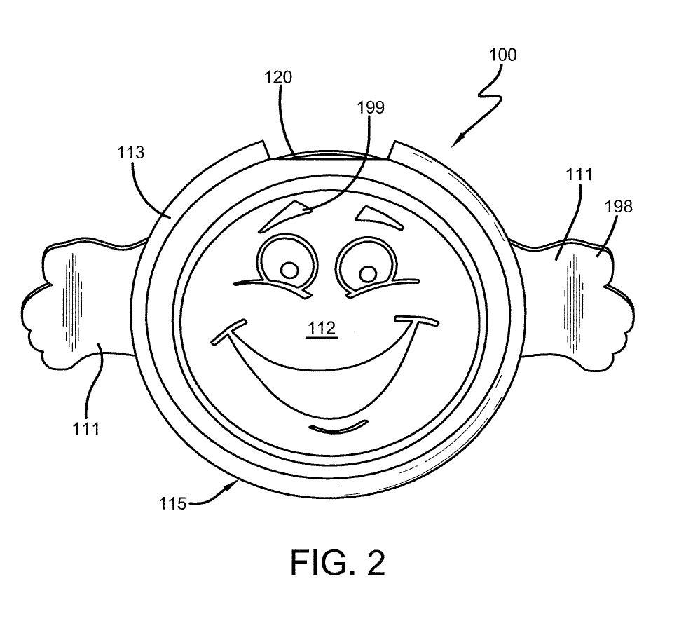

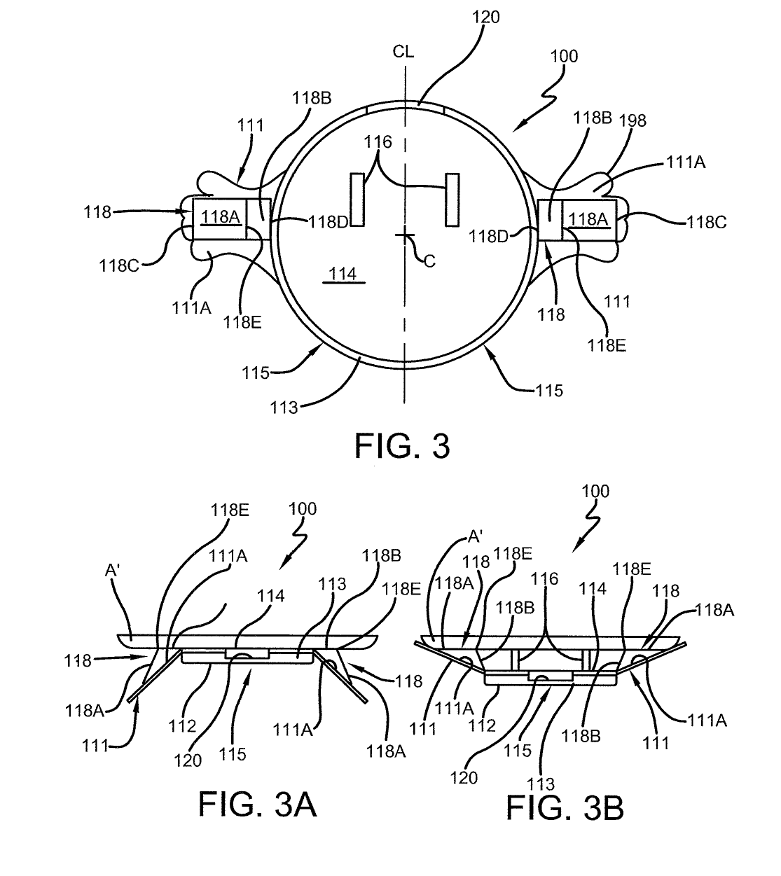

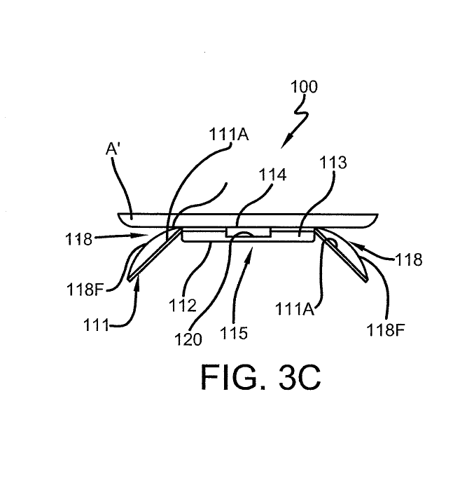

A levered electrical outlet plug protector of the present invention is indicated generally at 100 and is shown in FIGS. 2 and 3. Levered electrical outlet plug protector is installed into a socket that has a structure generally similar to the socket described above, to which the prior art electrical outlet plug protector is shown installed. Levered electrical outlet plug protector 100 is made from non-conducting material, such as plastic. Levered electrical outlet plug protector 100 includes a generally cylindrical body 115. Cylindrical body 115 has an outward surface 112, inserting surface 114 (FIGS. 3-3B), and a curved sidewall 113 raised along a circumference of the cylindrical body. Outward surface 112 includes a fanciful face 199 disposed on its surface. Inserting surface 114 includes a pair of dummy plug pins 116. Inserting surface 114 may optionally include a ground prong (not shown). Curved sidewall 113 includes a partially disconnected portion 120 which provides a space between inserting surface 114 and a socket front surface A′ (FIGS. 3A-4) when electrical outlet plug protector 10 is installed into the socket.

In accordance with one of the primary features of the present invention, levered electrical outlet plug protector 100 includes a pair of arms 111. Pair of arms 111 are shown in FIGS. 2-4 and described only by way of example. It is to be understood that the present invention may include more than a pair of arms 111. Each arm of pair of arms 111 is connected to cylindrical body by any suitable means, such as adhesive or other similar connecting means. Pair of arms 111 may also be integrally formed with cylindrical body 115. Pair of arms 111 includes an outline 198 in the shape of a fanciful arm or other such shape. The relative positions between the arms may be symmetrical about a center line CL which passes a center point C of inserting surface 114 as shown in FIG. 3. It is to be understood that the position of arms 111 may also be asymmetrical without changing the overall structure or operation of the present invention. A lever component 118 is attached to an inserting surface 111A of arm 111. Lever component 118 includes an outer inclined surface 118A and an inner inclined surface 118B. Outer inclined surface 118A and inner inclined surface 118B meet one another at an edge 118E. Edge 118E is parallel to centerline CL and spaced a distance from body 115 along arm 111. It is to be understood that lever component 118 may include one curved surface 118F (FIG. 3C) which continuously extends from an outer end 118C to an inner end 118D (FIG. 3) of the lever component. It is also to be understood that lever component 118 can be integrally formed with arm 111.

Having now described the overall structure of exemplary embodiment levered electrical outlet plug protector 100 of the present invention, the installation and removal of the levered electrical outlet plug protector will now be described in detail below.

With particular reference to FIG. 3A, electrical outlet plug protector 100 is installed into a socket B (FIG. 4) by inserting pair of dummy plug pins 116 into a pair of socket female openings B′ (FIG. 4). Once electrical outlet plug protector 100 is installed, it is relatively secured to socket B by a friction fit between dummy plug pins 116 and socket female openings B′. Inner inclined surface 118B of lever component 118 generally contacts socket front surface A′ once electrical outlet plug protector 100 is installed to socket B. In contrast, outer inclined surface 118A of lever component 118 generally does not contact socket front surface A′.

With particular reference to FIG. 3B, levered electrical outlet plug protector 100 is removed from socket B by first moving or depressing lever component 118 to make outer inclined surface 118A contact socket front surface A′, thereby lifting or detaching cylindrical body 115 from socket front surface A′. A finger is used to grab or pinch cylindrical body 115 or other suitable parts of levered electrical outlet plug protector 100, in order to grasp the levered electrical outlet plug and totally remove it from socket B. By way of example, lever component 118 can be moved by pushing pair of arms 111 into engagement with socket front surface A′. Outer inclined surface 118A of lever component 118 generally contacts socket front surface A′ when pair of arms 111 are fully engaged against the socket front surface, thereby lifting or detaching cylindrical body 115 from the socket front surface. In this manner, levered electrical outlet plug protector 100 is capable of protecting children from electrical shock while allowing for easy removal of the outlet plug protector while preventing the breaking of finger nails as well as preventing the possibility of injury to the ends of the fingers during removal of the outlet plug protector. The outlet plug protector is inexpensive, easy to manufacture and use, yet effective for protecting children.

It is to be understood that structure of the above-described electrical outlet plug protector may be altered or rearranged, or certain components omitted or added, without affecting the overall concept or operation of the invention. It is also to be understood that the present invention finds application in all types of sockets and plugs known to those skilled in the art, including types other than those shown and described herein, without affecting the concept or operation of the invention.

The present invention has been described with reference to a specific embodiment. It is understood that this description and illustration is by way of example and not by way of limitation. Potential modifications and alterations will occur to others upon a reading and understanding of this disclosure, and it is understood that the invention includes all such modifications and alterations and equivalents thereof.

In the foregoing description, certain terms have been used for brevity, clearness and understanding; but no unnecessary limitations are to be implied therefrom beyond the requirements of the prior art, because such terms are used for descriptive purposes and are intended to be broadly construed.

Having now described the features, discoveries and principles of the invention, the manner in which the levered electrical outlet plug protector is used and installed, the characteristics of the construction, arrangement and method steps, and the advantageous, new and useful results obtained; the new and useful structures, devices, elements, arrangements, process, parts and combinations are set forth in the appended claims.

What is claimed is:

1. An electrical outlet plug protector for an electrical outlet plug receptacle comprising:
A body with a centerline, an outward surface, and an inserting surface, the inserting surface having one or more projections disposable within said electrical outlet plug receptacle; and
at least one arm operatively connected to and extending laterally away from the body;
the at least one arm further comprising a lever means for removing said electrical outlet plug protector from the electrical outlet plug receptacle.

2. The electrical outlet plug protector of claim 1 wherein the lever means is integrally formed on an inserting surface of the at least one arm.

3. The electrical outlet plug protector of claim 1 wherein the lever means is rigidly attached to an inserting surface of the at least one arm.

4. The electrical outlet plug protector of claim 2 wherein the lever means further comprises an outer inclined surface and an inner inclined surface that meet at an edge parallel to the centerline and spaced a distance from the body along the at least one arm.

5. The electrical outlet plug protector of claim 2 wherein the lever means further comprises a curvature continuously extending from the body along the at least one arm to a distal arm end.

6. The electrical outlet plug protector of claim 1 wherein the body further comprises a sidewall, the sidewall being raised along a perimeter of the body.

7. The electrical outlet plug protector of claim 6 wherein the sidewall further comprises at least one notch;
the at least one notch providing a space between the inserting surface and an electrical outlet surface when the one or more projections are disposed within the electrical outlet plug receptacle.

8. The electrical outlet plug protector of claim 1 wherein one of the one or more projections is a ground pin.

9. The electrical outlet plug protector of claim 1 wherein the one or more projections is a pair of dummy plug pins.

10. The electrical outlet plug protector of claim 1 wherein the at least one arm is arranged symmetrically with respect to the centerline.

11. The electrical outlet plug protector of claim 1 wherein the at least one arm is arranged asymmetrically with respect to the centerline.

12. The electrical outlet plug protector of claim 1 wherein the outward surface of the body includes a fanciful face.

13. The electrical outlet plug protector of claim 1 wherein the at least one arm includes a fanciful arm shape.
